(19) United States
(12) Patent Application Publication
(10) Pub. No.: US 2010/0039518 A1
(43) Pub. Date: Feb. 18, 2010

(54) PORTABLE INFORMATION PRODUCT WITH LASER PROJECTION

(76) Inventor: Hao-Wen Chen, Taipei City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/605,275

(22) Filed: Oct. 23, 2009

Related U.S. Application Data
(63) Continuation-in-part of application No. 11/907,210, filed on Oct. 10, 2007.

(51) Int. Cl. H04N 9/10

(52) U.S. Cl. 348/196; 348/E09.011

(57) ABSTRACT

A portable information product with laser projection is disclosed. The portable information product can be a cellular phone, a portable computer, or a personal digital assistant, wherein the portable information product has a data processing device. The data processing device has a main circuit module for processing stored data and forming an image output signal according to the stored data. Additionally, a laser projection device is disposed in the data processing device and is electrically connected to the main circuit module. Specifically, the laser projection device has a laser LED module, an energy reduction module, and an image amplifying module. In which, the laser LED module generates a laser scanning projection according to the image output signal. After that, the laser scanning projection is transmitted to the energy reduction module for decreasing the energy level, and then the energy-reduced laser scanning projection is transmitted to the image amplifying module for enlarging the image size and projecting onto a display region. As a result, the data stored in the data processing device can be easily viewed by multiple users.

### CROSS REFERENCE TO RELATED APPLICATION

This application is a continuation-in-part of U.S. application Ser. No. 11/907210, filed on 10 Oct. 2007 and entitled “PORTABLE INFORMATION PRODUCT HAVING PROJECTION DEVICE WITH DIGITAL LIGHT PROCESSING”, now pending.

### BACKGROUND OF THE INVENTION

1. Field of the Invention

The present invention relates to a portable information product, and more particularly, to a portable information product having a projection device.

2. Description of the Related Art

Portable information products are becoming more and more popular. For example, cellular phones, portable computers, and personal digital assistants are all small in size and have various functions. It is easy for users to take portable information products with them for organizing their daily affairs or offering a source of entertainment at any time.

A conventional portable information product displays data on a display device. The display device of the conventional portable information product has limited in size, and is only designed for a single user to view. As such, it is difficult for others to watch the limited display device at the same time. It lacks practicality if a user wants to show information stored in the portable information product to others. For example, in the situation that the user is in a conference with several people.

As a result, the conventional portable information product isn't possible for multiple users to view the build-in display device conveniently at the same time. Therefore, the inventor proposes a portable information product with laser projection that allows multiple users to view the contents stored in the portable information product at the same time.

Accordingly, as discussed above, the conventional portable information product still has some drawbacks that could be improved upon. The present invention aims to resolve the drawbacks in the prior art.

### SUMMARY OF THE INVENTION

The primary object of the invention is to specify a portable information product having a laser projection device, wherein the laser projection device is disposed in a data processing device. Further, the laser projection device outputs an image output signal generated by the data processing device, so that multiple viewers can easily view the data stored in the data processing device.

For achieving the aforementioned objects, a portable information product with laser projection is disclosed. The portable information product includes a data processing device, and the data processing device has a laser projection device. In which, the data processing device has a main circuit module for processing stored data and forming an image output signal according to the stored data. The laser projection device is disposed in the data processing device and electrically connects to the main circuit module.

Specifically, the laser projection device can have a laser LED module which is electrically connected to the main circuit module, for receiving the image output signal generated by the main circuit unit, and for generating a laser scanning projection according to the image output signal. The laser projection device may further include an energy reduction module which is connected with the laser LED module, for reducing the energy of the laser scanning projection. And, the laser projection device further includes an image amplifying module which is connected with the energy reduction module, for enlarging the image size of the laser scanning projection.

The laser projection device is disposed in the data processing device. As such, the image output signal formed by the data processing device can be outputted via the laser projection device on a projection screen, so that multiple users can easily view the data stored in the data processing device.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a schematic block diagram of an embodiment of a portable information product with laser projection according to the present invention;

FIG. 2 is a perspective view of an embodiment of a portable information product with laser projection according to the present invention;

FIG. 3 is a perspective view of another embodiment of a portable information product with laser projection according to the present invention;

FIG. 4 is a perspective view of another embodiment of a portable information product with laser projection according to the present invention; and

FIG. 5 is a perspective view of another embodiment of a portable information product with laser projection according to the present invention.

### DETAILED DESCRIPTION OF THE PREFERRED EMBODIMENTS

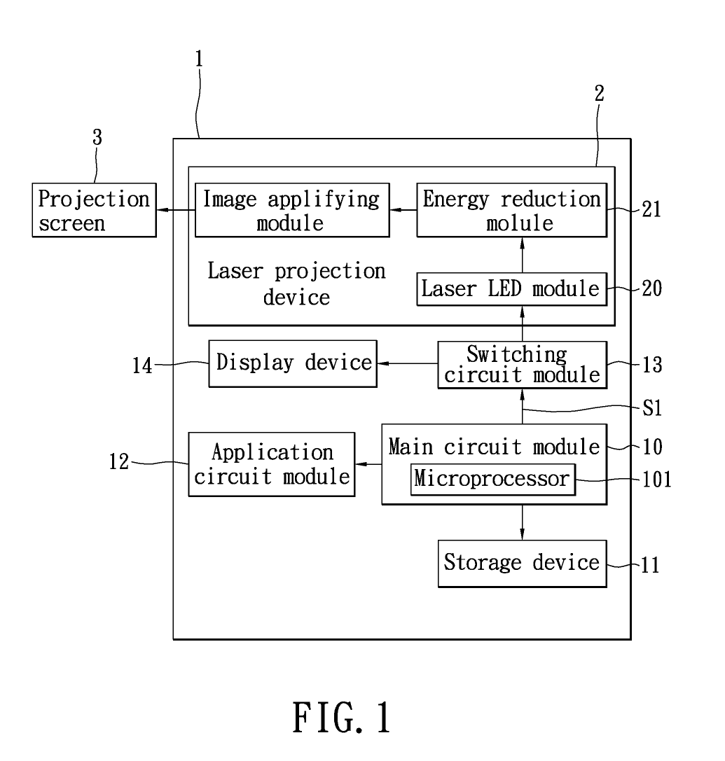

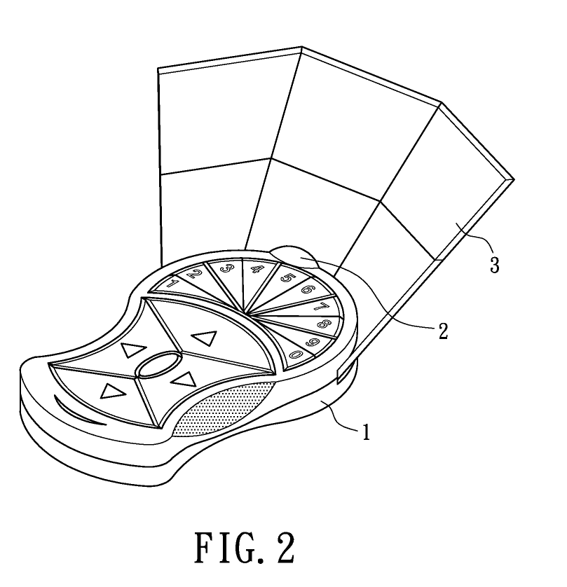

The present invention provides a portable information product with laser projection. FIG. 1 shows an embodiment of an interior system of a portable information product with laser projection. And as shown in FIG. 2 to FIG. 5, the portable information product may be a cellular phone, a portable computer, a personal digital assistant, or any type of portable information product. The portable information product comprises a data processing device 1 and a projection screen 3, in which the data processing device 1 has a laser projection device 2.

The data processing device 1 includes a main circuit module 10. Wherein the main circuit module 10 has a microprocessor 101, various essential program processors (not shown), various essential memories (not shown), and other electronic elements, for processing stored data and forming an image output signal S1 according to the stored data.

The data processing device 1 further includes a storage device 11 and an application circuit module 12. The storage device 11 may be a hard disk drive, a card reader, or any device for storing data. In which, the storage device 11 electrically connects to the main circuit module 10 for storing data of the data processing device 1. The application circuit module 12 may be a control circuit module, a battery circuit module, or any other type of functional application circuit module. For example, the control circuit module may be an audio circuit module for emitting sound, a charging circuit module for charging a rechargeable battery, etc. And, the battery circuit module can be a module for providing requisite electrical power to the portable information product, and can be either rechargeable or primary batteries. Furthermore, the application circuit module 12 electrically connects to the main circuit module 10 for processing data stored in the storage device 11.

The laser projection device 2 is disposed in the data processing device 1 and electrically connects to the main circuit module 10. Specifically, the laser projection device 2 has a laser LED module 20, an energy reduction module 21, and an image amplifying module 22. In which, the laser LED module 20 couples with the main circuit module 10 for receiving the image output signal S1, and may have a red-light laser LED, a green-light laser LED, and a blue-light laser LED.

The work scheme of laser LED module 20 is that, the laser LED module 20 rapidly scans the red, green, and blue laser light onto the display region according to the received image output signal S1. By adjusting the luminous intensity of the scanning laser light, various of different images or pictures can be displayed onto the display region. For further discussion, although the laser LED module 20 uses laser “points” to scan the image onto the display region, the viewers will see a full “plane” of image because of the visual persistence of human eyes.

Additionally, if the laser scanning projection is outputted onto the display region right after it is produced by the laser LED module 20, the viewer's eyes will get harmful stimulations because of the high energy level of the outputted laser scanning projection. Thus, before the laser scanning projection is outputted from the laser projection device 2, the laser scanning projection is sent to the energy reduction module 21 for reducing energy level. The energy reduction module 21 includes at least one light filter for diminishing the energy of the laser scanning projection sent from the laser LED module 20, in order to avoid the viewers' eyes getting unwilling harm.

Furthermore, after the energy of the laser scanning projection was decreased by the energy reduction module 21, the image amplifying module 22 then enlarge the image size of the laser scanning projection, in order to make the image size of the laser scanning projection large enough for user viewing. In which, the image amplifying module 22 may include an image amplifying lens for enlarging the image size of the laser scanning projection.

Please refer to FIG. 1 again, the data processing device 1 further includes a switching circuit module 13 and a display device 14. In which, the switching circuit module 13 electrically connects between the main circuit module 10 and the laser projection device 2, and between the main circuit module 10 and the display device 14. And the display device 14 may be a liquid crystal display (LCD).

In this embodiment, the portable information product with laser projection uses the laser projection device 2 and/or the display device 14 to display the image output signal S1 which is generated according to the stored data by the main circuit module 10. By switching the switching circuit module 13, the image output signal S1 can be alternatively transmitted to the laser projection device 2 and/or the display device 14 for display. The portable information product may further comprise a projection screen 3 for receiving the laser scanning projection.

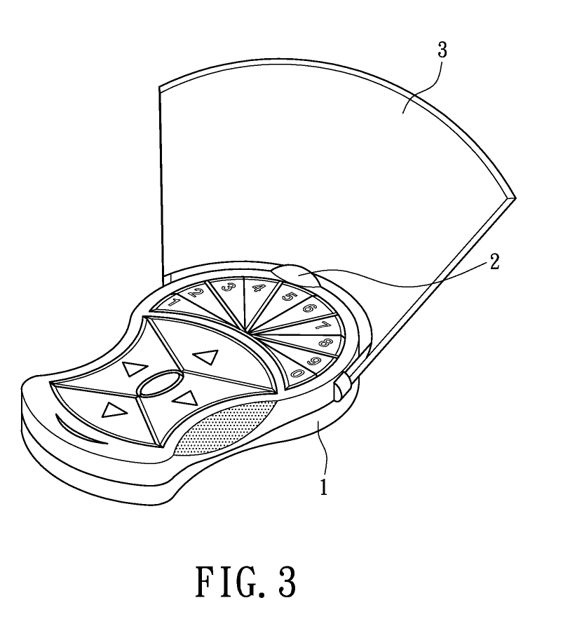

Specifically, as shown in FIG. 2, the projection screen 3 can retrievably connect to the data processing device 1. Or, as shown in FIG. 3, the projection screen 3 can detachably assemble to the data processing device 1, in which the projection screen 3 can be a plane surface, a curved surface, or any irregular surface. For example, the portable information product may display image on top of a table, on a cement wall, or even on somebody's back.

When a user uses the laser projection device 2 to display the data stored in the data processing device 1, the image output signal SI which is generated by the main circuit module 10 is transmitted to the laser LED module 20 via the switching circuit module 13, for generating the laser scanning projection. The laser scanning projection is then transmitted to the energy reduction module 21 for diminishing the energy level. After that, the energy-reduced laser scanning projection is sent to the image amplifying module 22 for enlarging image size and projecting onto the projection screen 3. As a result, the portable information product can let multiple users view the image at the same time.

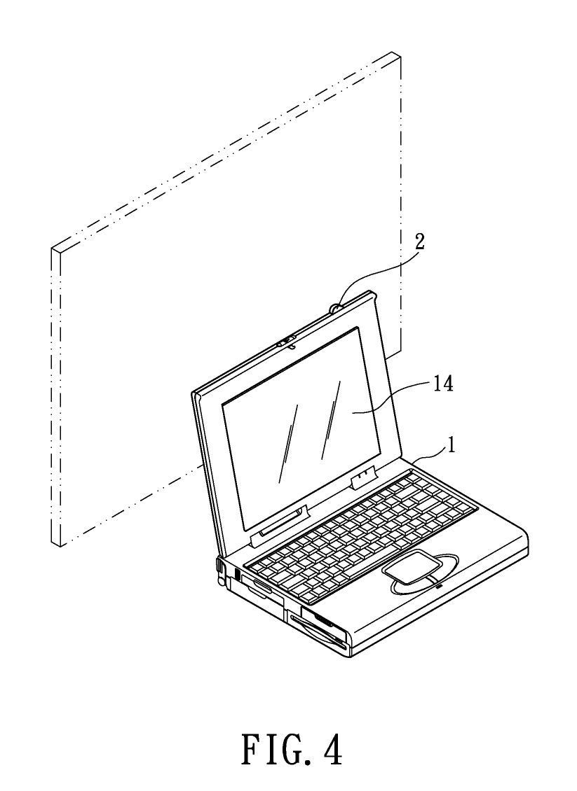

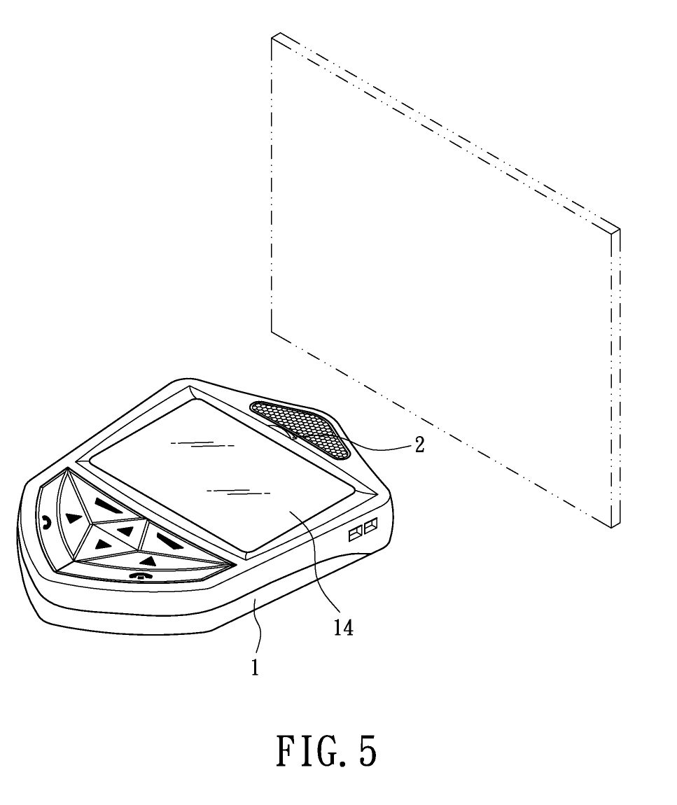

As shown in FIG. 4 and FIG. 5, the portable information product may not need a projection screen 3. In these cases, the image amplifying module 22 can directly project the image of the laser scanning projection onto an appropriate surface outside of the data processing device 1. The user may also use the display device 14 to display data stored in the data processing device 1, or use the laser projection device 2 and the display device 14 to display data stored in the data processing device 1 simultaneously.

As indicated above, the portable information product with laser projection according to the present invention has the following advantages:

(1) The laser projection device 2 is disposed in the data processing device 1, so that the image output signal SI formed by the data processing device 1 is outputted via the laser projection device 2. Thus, the data stored in the data processing device 1 can be viewed easily by multiple viewers.

(2) The projection screen 3 can retrievably connect to the data processing device 1 or detachably assemble with the data processing device 1. Or, the portable information product may not need a projection screen 3. Therefore, the portable information product with laser projection according to the present invention is more convenient to use.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A portable information product with laser projection, comprising:
a data processing device, further comprising:
a storage device for storing data of the data processing device;
a main circuit module electrically connecting to the storage device, in which the main circuit module is for processing data of the data processing device and for forming an image output signal according to the data;
an application circuit module electrically connecting to the main circuit module, in which the application circuit module is a control circuit module or a battery circuit module;
a display device which is for receiving and displaying the image output signal;
a laser projection device electrically connecting to the main circuit module, for receiving the image output signal and generating a laser scanning projection according to the image output signal;
a switching circuit module electrically connecting to the main circuit module, the laser projection device, and the display device, in which the switching circuit module is for receiving the image output signal and alternatively transmitting the image output signal to the laser projection device and/or the display device; and
a projection screen for receiving the laser scanning projection which is outputted by the laser projection device, wherein the projection screen retrievably connects to the data processing device or detachably assembles to the data processing device, and the projection screen is a plane surface, a curved surface, or an irregular surface.

2. The portable information product as in claim 1, wherein the laser projection device includes:
a laser LED module electrically connecting with the switching circuit module, in which the laser LED module is for receiving the image output signal, and generating the laser scanning projection according to the image output signal.

3. The portable information product as in claim 2, wherein the laser LED module includes a red-light laser LED, a green-light laser LED, and a blue-light laser LED.

4. The portable information product as in claim 2, wherein the laser projection device includes:
an energy reduction module electrically connecting with the laser LED module, in which the energy reduction module is for reducing energy of the laser scanning projection.

5. The portable information product as in claim 4, wherein the energy reduction module includes at least one light filter.

6. The portable information product as in claim 4, wherein the laser projection device includes:
an image amplifying module electrically connecting with the energy reduction module, in which the image amplifying module is for enlarging image size of the laser scanning projection.

7. The portable information product as in claim 6, wherein the image amplifying module includes at least an image amplifying lens.

8. The portable information product as in claim 1, wherein the portable information product is a cellular phone.

9. The portable information product as in claim 1, wherein the portable information product is a portable computer.

10. The portable information product as in claim 1, wherein the portable information product is a personal digital assistant.

11. The portable information product as in claim 1, wherein the portable information product is a multimedia player.

12. The portable information product as in claim 1, wherein the main circuit module of the data processing device has a microprocessor for processing data of the data processing device.
